(19) United States
(12) Patent Application Publication
(10) Pub. No.: US 2025/0192237 A1
(43) Pub. Date: Jun. 12, 2025

(54) SECONDARY BATTERY AND BATTERY PACK INCLUDING THE SAME

(71) Applicant: Samsung SDI Co., Ltd., Yongin-si (KR)

(72) Inventor: Kee Yun KIM, Yongin-si (KR)

(21) Appl. No.: 18/665,256

(22) Filed: May 15, 2024

(30) Foreign Application Priority Data
Dec. 6, 2023 (KR) 10-2023-0175374

(51) Int. Cl. H01M 10/0585; H01M 10/052; H01M 50/552

(52) U.S. Cl. CPC H01M 10/0585; H01M 10/052; H01M 50/552

(57) ABSTRACT

A secondary battery includes: a case having a space therein; an electrode assembly in the space of the case; a cap plate coupled to an upper portion of the case to seal the case; a current collector comprising a terminal connection part between the electrode assembly and the cap plate and an electrode connection part connected to an end of the terminal connection part in a vertical direction and between the electrode assembly and the case; an electrode terminal coupled to the terminal connection part of the current collector by passing through the cap plate; and an insulating member interposed between the cap plate and the electrode assembly, wherein the insulating member comprises an insertion groove in a side surface thereof, and at least a portion of the terminal connection part is inserted into the insertion groove of the insulating member.

### CROSS-REFERENCE TO RELATED APPLICATION

The present application claims priority to and the benefit of Korean Application No. 10-2023-0175374, filed on Dec. 6, 2023, in the Korean Intellectual Property Office, the entire disclosure of which is incorporated herein by reference.

### BACKGROUND

### 1. Field

Aspects of some embodiments of the present disclosure relate to a secondary battery and a battery pack including the same.

### 2. Description of the Related Art

A secondary battery is a chargeable and dischargeable battery, unlike a primary battery that is not chargeable. Low-capacity secondary batteries, in which a single battery cell is packaged in a pack, are used in small and portable electronic devices such as mobile phones and camcorders. In addition, large-capacity secondary battery modules provided in battery pack units, in which dozens of battery packs are connected, are being widely used as power sources for driving motors in hybrid vehicles, electric vehicles, etc.

Secondary batteries are manufactured in various shapes such as cylindrical and prismatic types, and each of the secondary batteries is configured so that an electrode assembly, which is manufactured by interposing a separator that is an insulator between a positive electrode plate and a negative electrode plate, and an electrolyte are embedded and installed in a case, and a cap plate is installed on the case. In addition, the secondary battery may include a retainer and/or insulating plate to electrically insulate the electrode assembly and the case and/or the cap plate.

The above information disclosed in this Background section is only for enhancement of understanding of the background and therefore the information discussed in this Background section does not necessarily constitute prior art.

### SUMMARY

Aspects of some embodiments of the present disclosure include a secondary battery that may have relatively reduced material costs and a relatively simplified manufacturing process through reduction of the number of components, and a battery pack including the same.

However, the technical characteristics of embodiments according to the present disclosure are not limited to the above-described characteristics, and other characteristics not mentioned can be more clearly understood by those skilled in the art from the description of the invention described below.

According to some embodiments, a secondary battery includes: a case having a space therein; an electrode assembly accommodated in the space of the case; a cap plate coupled to an upper portion of the case to seal the case; a current collector including a terminal connection part between the electrode assembly and the cap plate and an electrode connection part connected to an end of the terminal connection part in a vertical direction and between the electrode assembly and the case; an electrode terminal coupled to the terminal connection part of the current collector by passing through the cap plate; and an insulating member interposed between the cap plate and the electrode assembly, wherein the insulating member includes an insertion groove defined in a side surface thereof, and at least a portion of the terminal connection part is inserted into the insertion groove of the insulating member.

According to some embodiments, the insulating member may be provided in a plate shape having a thickness and comprises a pair of long sides and a pair of short sides connected to the pair of long sides, and the insertion groove may be defined in each of the pair of long sides of the insertion groove.

According to some embodiments, the cap plate may include: a vent part defined in a central area of the cap plate; an electrolyte injection port provided outside the vent part; and a rivet hole defined to perform lower riveting of the electrode terminal.

According to some embodiments, the insulating member may include: a lower vent hole defined in a central area thereof to correspond to a position of the vent part defined in the cap plate; and an injection hole defined outside the lower vent hole to correspond to the electrolyte injection port provided in the cap plate.

According to some embodiments, the lower vent hole of the insulating member may be defined below the vent part.

According to some embodiments, the lower vent hole of the insulating member may have a size equal to or greater than that of the vent part.

According to some embodiments, the insulating member may be provided to be symmetrical left and right with respect to the lower vent hole.

According to some embodiments, the insulating member may have a lower rivet hole defined in an edge area thereof to perform the lower riveting of the electrode terminal.

According to some embodiments, the cap plate and the insulating member may have the rivet hole and the lower rivet holes defined at positions corresponding to each other, respectively, so as to perform the lower riveting of the electrode terminal, and each of the rivet hole of the cap plate and the lower rivet hole of the insulating member may be defined at a position corresponding to the position of the electrode terminal.

According to some embodiments, the terminal connection part may have a terminal rivet hole defined to perform the lower riveting of the electrode terminal.

According to some embodiments, the rivet hole of the cap plate, the lower rivet hole of the insulating member, and the terminal rivet hole of the terminal connection part may be defined at positions corresponding to each other, respectively.

According to some embodiments, the electrode connection part may extend to an end of the terminal connection part and be connected to a side surface of the electrode assembly.

According to some embodiments, the electrode connection part may be coupled to an end of the terminal connection part and is connected to a side surface of the electrode assembly.

According to some embodiments, the terminal connection part may be spaced apart from the electrode assembly by the insulating member.

According to some embodiments, the cap plate, the insulating member, and the terminal connection part may have a rivet hole, a lower rivet hole, and a terminal rivet hole, which are defined to perform lower riveting of the electrode terminal, respectively, wherein the rivet hole of the cap plate, the lower rivet hole of the insulating member, and the terminal rivet hole of the terminal connection part may be defined at positions corresponding to each other, respectively.

According to some embodiments, a vent part may be defined at one side of the cap plate, and a lower vent hole may be defined at one side of the insulating member, the vent hole of the insulating member may be defined below the vent part of the cap plate.

According to some embodiments, a battery pack includes: a plurality of battery modules which respectively include the plurality of secondary batteries described above; and a housing configured to accommodate the plurality of battery modules.

### BRIEF DESCRIPTION OF THE DRAWINGS

The following drawings attached in this specification illustrate aspects of some embodiments of the present invention and function to make further understood the technical spirit of the present invention along with the detailed description of the invention, and thus, the present invention should not be construed as being limited to only the drawings;

FIG. 1 is a perspective view of a secondary battery according to some embodiments;

FIG. 2 is a cross-sectional view taken along the line 2-2 of FIG. 1;

FIG. 3 is an exploded perspective view of a current collector and an electrode assembly of the secondary battery of FIG. 1;

FIG. 4 is an exploded perspective view of a cap plate, first and second electrode terminals, a lower insulating member, and first and second current collector of the secondary battery according to some embodiments;

FIG. 5 is a plan view of the lower insulating member of the secondary battery according to some embodiments;

FIG. 6 is a side view of the lower insulating member of the secondary battery according to some embodiments;

FIGS. 7 to 11 illustrate views sequentially showing a process of manufacturing a secondary battery according to some embodiments;

FIG. 12 is a perspective view of an example of a battery module;

FIGS. 13A and 13B illustrate perspective views of an example of a battery pack; and

FIGS. 14A and 14B illustrate perspective and side views of examples of a vehicle body and a vehicle components.

### DETAILED DESCRIPTION

Hereinafter, aspects of some embodiments of the present disclosure will be described in more detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C, and/or any combination of A, B, and/or C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be located in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components ”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used herein are for describing aspects of some embodiments of the present disclosure and are not intended to be limiting of embodiments according to the present disclosure.

Hereinafter, in a prismatic battery according to some embodiments of the present disclosure, one of prismatic batteries is selected and the selected battery is described as having a general structure, and the general structure of the prismatic battery will be described in the case of generally applicable technology. However, embodiments according to some embodiments of the present disclosure are not limited thereto, and a case may be formed in various shapes such as a circular shape, a pouch shape, and the like. In addition, the case may be made of a metal such as aluminum, an aluminum alloy, and nickel-plated steel, or a laminate film or plastic that forms a pouch.

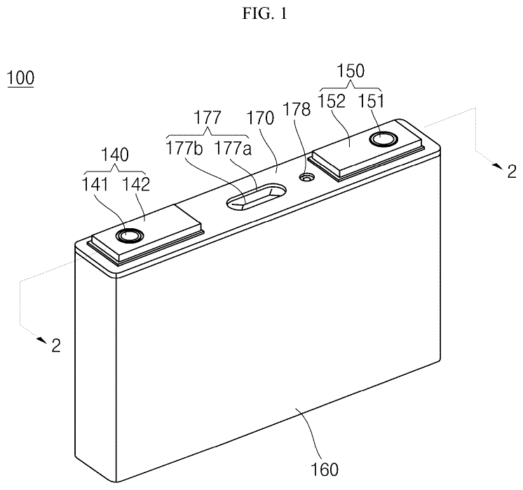

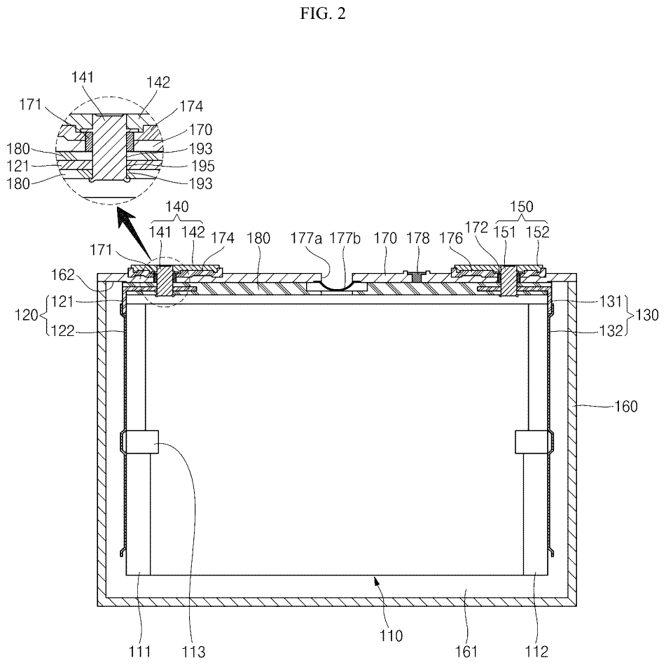

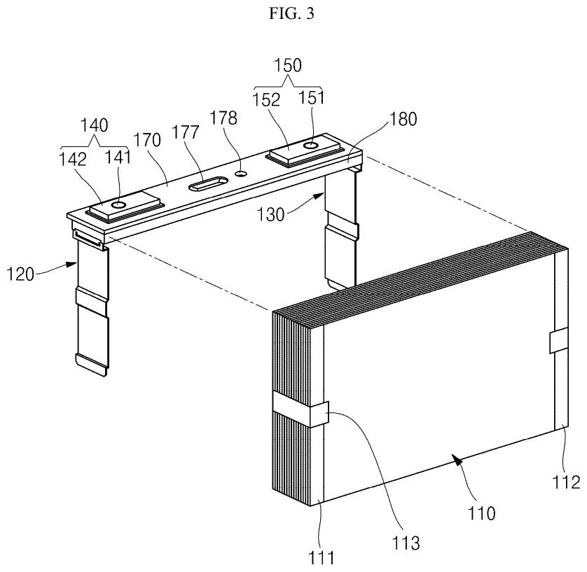

FIG. 1 is a perspective view of a secondary battery according to some embodiments, FIG. 2 is a cross-sectional view taken along the line 2-2 of FIG. 1, and FIG. 3 is an exploded perspective view of a current collector and an electrode assembly of the secondary battery of FIG. 1.

Referring to FIGS. 1 to 3, a secondary battery 100 according to some embodiments may include an electrode assembly 110, first and second current collectors 120 and 130 electrically connected to the electrode assembly 110, a case 160 configured to accommodate or house first and second electrode terminals 140 and 150, the electrode assembly 110, and an electrolyte therein, and a cap plate 170 coupled to an opening of the case 160 to seal the case 160.

The electrode assembly 110 may be formed by stacking a plurality of stacks of a first electrode plate, a separator, and a second electrode plate, each of which is provided or formed in a thin plate or film shape. According to some embodiments, the first electrode plate may serve as a first polarity electrode, for example, a negative electrode, and the second electrode plate may serve as a second polarity electrode, for example, a positive electrode. According to some embodiments, the first electrode plate and the second electrode plate may be formed with different polarities according to various embodiments.

The first electrode plate may include a first base material and a first active material layer located on the first base material. If the first electrode plate serves as the negative electrode, the first base material may be made of a metal or conductive material foil, for example, copper or nickel, and the first active material layer may include, for example, graphite. According to some embodiments, a first non-coating portion 111 on which the first active material layer is not located may be provided on the first base material, and the first non-coating portion 111 may provide a path for a current flow between the first electrode plate and the outside.

According to some embodiments, the first non-coating portion 111 may be arranged to overlap at the same position if the first electrode plate is stacked, thereby providing a multi-tap structure. The first non-coating portion 111 may be formed to protrude to one side of the electrode assembly 110. According to some embodiments, a plurality of first non-coating portions 111 may be welded to each other to provide one first current collector tab. The first non-coating portion 111 may be aligned to one side of the electrode assembly 110 to protrude.

The second electrode plate may include a second base material and a second active material layer located on the second base material. If the second electrode plate serves as the positive electrode, the second base material may be made of, for example, aluminum foil, and the second active material layer may include, for example, transition metal oxide. According to some embodiments, a second non-coating portion 112 on which the second active material layer is not located may be provided on the second base material, and the second non-coating portion 112 may provide a path for a current flow between the second electrode plate and the outside.

According to some embodiments, the second non-coating portion 112 may be arranged to overlap at the same position if the second electrode plate is stacked, thereby providing a multi-tap structure. The second non-coating portion 112 may be provided to protrude to the other side of the electrode assembly 110. According to some embodiments, a plurality of second non-coating portions 112 may be welded to each other to provide one second current collector tab. The second non-coating portion 112 may be aligned to the other side of the electrode assembly 110 to protrude.

The separator may serve to prevent or reduce instances of a short circuit between the first electrode plate and the second electrode plate while allowing movement of lithium ions. The separator may be made of, for example, polyethylene film, polypropylene film, polyethylene-polypropylene film, etc.

According to some embodiments, after the plurality of electrode plates are stacked, the electrode assembly 110 may be maintained in the stacked state through a separate insulating tape 113 attached to a partial area on an outer surface thereof. According to some embodiments, the insulating tape 113 may serve to fix or secure the electrode assembly 110 to be maintained in its shape so that the electrode assembly 110 is welded to the current collectors 120 and 130 at correct positions, and the structure of the electrode assembly 110 is maintained in a structure of the final secondary battery.

According to some embodiments, the electrode assembly 110 and the electrolyte may be substantially accommodated in the case 160. The electrolyte may include an organic solvent such as ethylene carbonate (EC), propylene carbonate (PC), diethyl carbonate (DEC), ethyl methyl carbonate (EMC), or dimethyl carbonate (DMC), and lithium salt such as LiPF₆ or LiBF₄. The electrolyte may be liquid, solid, or gel.

The first current collector plate 120 may be made of a conductive material such as nickel and may be in contact with the first non-coating portion 111 protruding to one end of the electrode assembly 110 and thus be electrically connected to the first electrode plate. The first current collector 120 may include a first terminal connection part 121 interposed between the electrode assembly 110 and the cap plate 170 and a first electrode connection part 122 extending vertically from an end of the first terminal connection part 121 and connected to the electrode assembly 110. The first terminal connection part 121 and the first electrode connection part 122 may be coupled to each other by welding. According to some embodiments, the first electrode connection part 122 may be referred to as a sub plate. According to some embodiments, the first electrode connection part 122 may extend from the end of the first terminal connection part 121 and be connected to a side surface of the electrode assembly 110.

The second current collector 130 may be made of a conductive material such as nickel and be in contact with the second non-coating portion 112, which protrudes to the other end of the electrode assembly 110, and thus be electrically connected to the second electrode plate. The second current collector 130 may include a second terminal connection part 131 interposed between the electrode assembly 110 and the cap plate 170 and a second electrode connection part 132 extending vertically from an end of the second terminal connection part 131 and connected to the electrode assembly 110. The second terminal connection part 131 and the second electrode connection part 132 may be coupled to each other by welding. According to some embodiments, the second electrode connection part 132 may be referred to as a sub plate. According to some embodiments, the second electrode connection part 132 may extend from an end of the second terminal connection part 131 and be connected to a side surface of the electrode assembly 110.

The first electrode terminal 140 may be made of a conductive material such as nickel and may be coupled to the first current collector 120 by passing through the cap plate 170 and thus be electrically connected to the first current collector 120. The first electrode terminal 140 may include a first rivet terminal 141 and a first terminal plate 142.

The first rivet terminal 141 may protrude upward by a certain length through the cap plate 170 and may be electrically connected to the first terminal connection part 121 at a lower portion of the cap plate 170. An upper portion of the first rivet terminal 141 may be coupled to the first terminal plate 142 at the upper portion of the cap plate 170, and a lower portion of the first rivet terminal 141 may be connected to the first terminal connection part 121 at the lower portion of the cap plate 170 by riveting and/or welding.

The second electrode terminal 150 may be made of a conductive material such as aluminum and may be coupled to the second current collector 130 by passing through the cap plate 170 and thus be electrically connected to the second current collector 130. The second electrode terminal 150 may include a second rivet terminal 151 and a second terminal plate 152.

The second rivet terminal 151 may protrude upward by a certain length through the cap plate 170 and may be electrically connected to the second terminal connection part 131 at the lower portion of the cap plate 170. An upper portion of the second rivet terminal 151 may be coupled to the second terminal plate 152 at the upper portion of the cap plate 170, and a lower portion of the second rivet terminal 151 may be connected to the second terminal connection part 131 at the lower portion of the cap plate 170 by riveting and/or welding.

The case 160 may define a space or cavity 161 therein, and the electrode assembly 110 and the first and second current collectors 120 and 130 may be located in the space 161 inside the case 160. The case 160 may be made of a conductive material or metal such as aluminum, an aluminum alloy, or nickel-plated steel and may have an opening 162 into which the electrode assembly 110 and the first and second current collectors 120 and 130 are inserted and seated may be provided in a hexahedral (or an approximately hexahedral shape). A cap plate 170 may be coupled to the opening 162 of the case 160 to seal the case 160. An inner surface of the case 160 may be insulated to prevent or reduce instances of electrical short circuits from occurring therein. That is, according to some embodiments, an insulating material may be formed or coated over an internal surface of the case 160 to prevent or reduce instances of electrical shorts between the electrode assembly 110 and the case 160.

The cap plate 170 may be coupled to the case 160 to seal the opening 162 of the case 160. As described above, the first rivet terminal 141 of the first electrode terminal 140 and the second rivet terminal 151 of the second electrode terminal 150 may be coupled to the first and second current collectors 120 and 130 located inside the case 160 by passing through the cap plate 170 and thus be electrically connected to the first and second collectors 120 and 130, respectively.

According to some embodiments, a first seal gasket 171 may be provided to seal a gap between the first terminal plate 142 and the cap plate 170 and/or the first rivet terminal 141 and the cap plate 170. According to some embodiments, a second seal gasket 172 may be provided to seal a gap between the second terminal plate 152 and the cap plate 170 and/or the second rivet terminal 151 and the cap plate 170. Each of the first and second seal gaskets 171 and 172 may be made of an insulating material and may be provided to have electrical insulation and sealing functions. The first and second seal gaskets 171 and 172 may prevent or reduce instances of external moisture or contaminants being permeated into the secondary battery 100 or prevent or reduce leakage of the electrolyte contained within the secondary battery 100 to the outside.

According to some embodiments, an upper insulating member 174 for electrical insulation between the first terminal plate 142 and the cap plate 170, and/or electrical insulation between the first rivet terminal 141 and the cap plate 170 may be provided. The upper insulating member 174 may have a shape corresponding to a bottom surface of the first terminal plate 142 and may be provided with a through-hole through which the first rivet terminal 141 passes. The upper insulating member 174 may be configured to block the first terminal plate 142 and/or the rivet terminal 141 from being in direct contact with the cap plate 170 to provide the electrical insulation between the first terminal plate 142 and the rivet terminal 141. The upper insulating member 174 may be made of a plastic material with high electrical insulation such as polyamide (PA), polyethylene (PE), or polypropylene (PP). According to some embodiments, the upper insulation member 174 may be referred to as an upper insulator.

A lower insulating member 180 may be interposed between each of the first and second current collectors 120 and 130 and the cap plate 170 to transmit electricity between the first and second current collectors 120 and 130 and the cap plate 170. The lower insulating member 180 may be made of a plastic material with high electrical insulation such as polyamide (PA), polyethylene (PE), or polypropylene (PP). According to some embodiments, the lower insulating member 180 may be referred to as a lower insulator.

According to some embodiments, a conductor 176 may be interposed between the second terminal plate 152 and the cap plate 170. The conductor 176 may have a shape corresponding to a bottom surface of the second terminal plate 152 and may be provided with a through-hole through which the first rivet terminal 151 passes.

According to some embodiments, a vent part 177 may be provided in a central area of the cap plate 170. The vent part 177 may include a vent hole 177a defined in the cap plate 170 and a vent member 177b installed in the vent hole 177a. The vent member 177b may be installed to block the vent hole 177a and may have a shape that protrudes convexly downward. The vent member 177b may include at least one notch. According to some embodiments, if a gas is generated due to overcharging or abnormal operation of the secondary battery 100, the vent member 177b may be cut along the notch that may be deformed convexly upward by a pressure. The cut vent member 177b may release the gas to the outside to prevent or reduce damage to (e.g., explosion, expansion, etc.) the secondary battery 100.

According to some embodiments, the lower insulating member 180 located below the cap plate 170 may also have a lower vent hole 181, and the lower vent hole 181 may be defined in a central area of the lower insulating member 180, which corresponds to a position of the vent part 177 of the cap plate 170. According to some embodiments, the gas in the case 160 may be discharged to the outside through the lower vent hole 181 and the vent part 177 of the lower insulating member 180. According to some embodiments, a size of the lower vent hole 181 of the lower insulating member 180 may be equal to or greater than that of the vent part 177. According to some embodiments, the lower insulating member 180 may be provided to be symmetrical left and right with respect to the lower vent hole 181.

The cap plate 170 may be provided with an electrolyte injection port 173, and a stopper 178 may be separably installed in the electrolyte injection port 173 of the cap plate 170. The stopper 178 may be configured to seal the electrolyte injection port 173 of the cap plate 170.

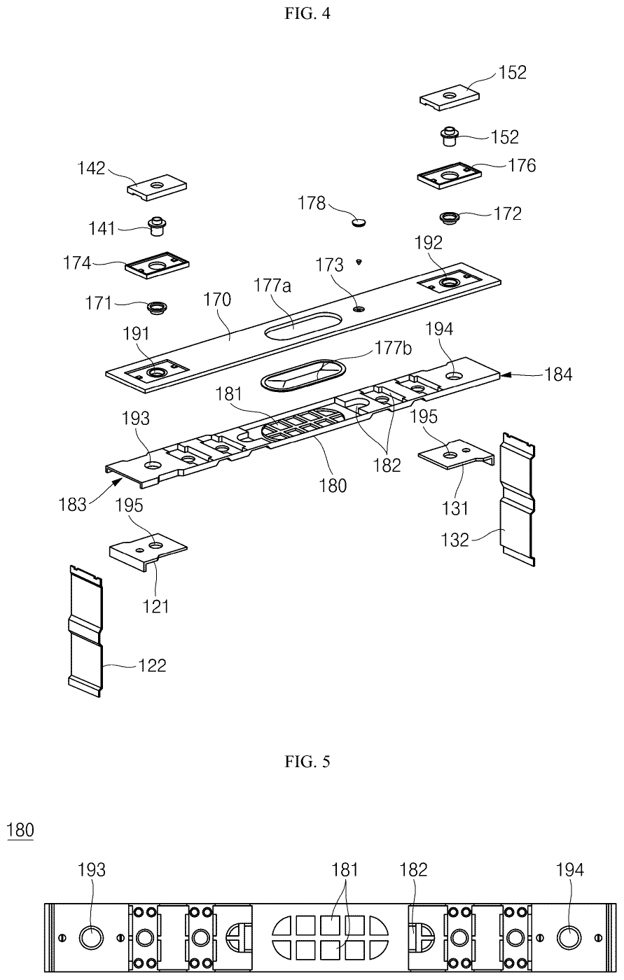

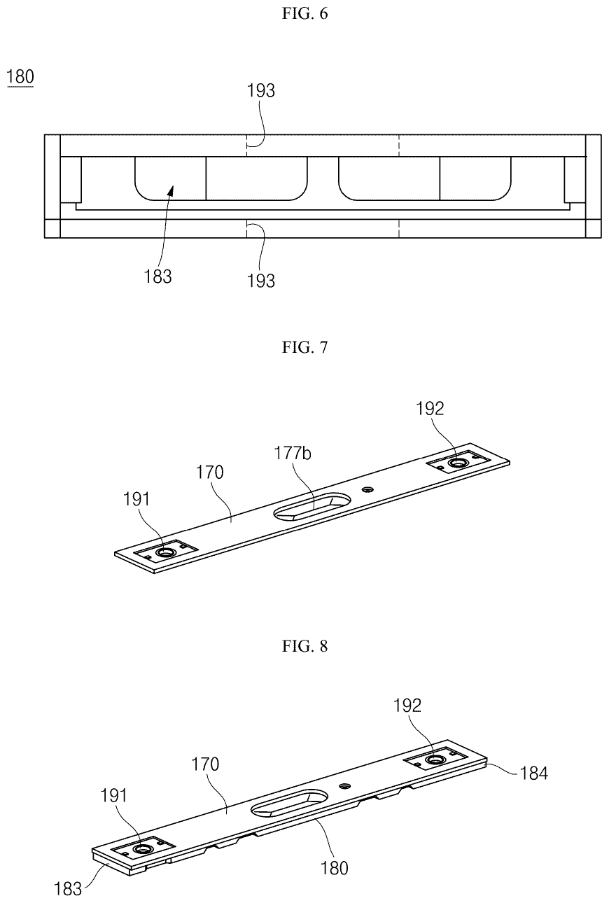

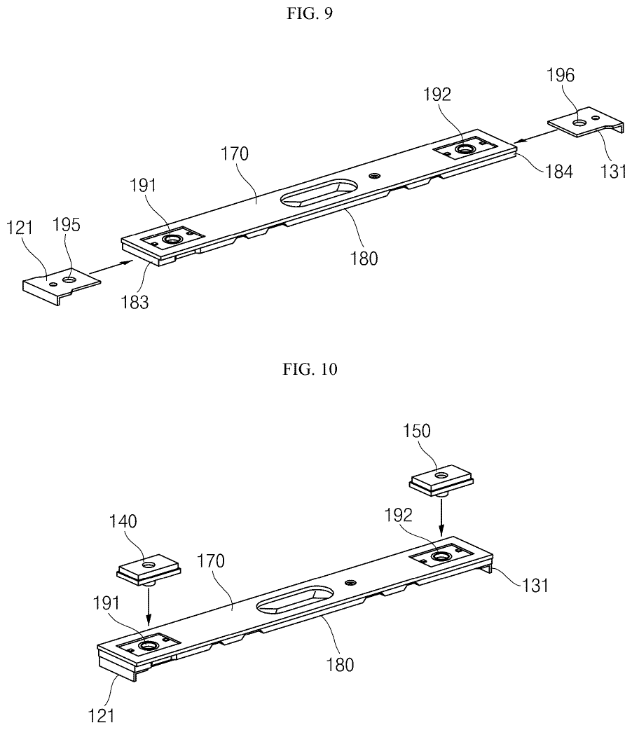

FIG. 4 is an exploded perspective view of the cap plate, the first and second electrode terminals, the lower insulating member, and the first and second current collector of the secondary battery according to some embodiments, FIG. 5 is a plan view of the lower insulating member of the secondary battery according to some embodiments, and FIG. 6 is a side view of the lower insulating member of the secondary battery according to some embodiments.

Referring to FIGS. 4 to 6, the lower insulating member 180 may be provided in a plate shape having a thickness and include a pair of long sides and a pair of short sides connected to the pair of long sides. That is, a first insertion groove 183 may be defined in one surface of the lower insulating member 180, and one side of the first current collector 120, that is, at least a portion of the first terminal connection part 121 may be inserted into the first insertion groove 183. Referring to FIG. 6, the first insertion groove 183 having the outside that is opened may be defined in one end of the lower insulating member 180. According to some embodiments, referring to that shown within a dotted circle in FIG. 2, an end of the first terminal connection part 121 may be inserted into the first insertion groove 183. As a result, the existing retainer provided to support the bottom surface of the first terminal connection part 121 may be removable, and thus, material costs may be relatively reduced, and the process may be relatively simplified.

Similarly, a second insertion groove 184 may be defined in the other surface of the lower insulating member 180, and one side of the second current collector 130, that is, at least a portion of the second terminal connection part 131 may be inserted into the second insertion groove 184. According to some embodiments, the first terminal connection part 121 and the second terminal connection part 131 may be spaced apart from the electrode assembly 110 by the lower insulating member 180.

The first rivet terminal 141 of the first electrode terminal 140 may be configured to be lower-riveted by passing through the cap plate 170, the lower insulating member 180, and the first terminal connection part 121. According to some embodiments, the cap plate 170 may be provided with a first rivet hole 191 in one edge area corresponding to the installation position of the first rivet terminal 141.

According to some embodiments, the lower insulating member 180 may include a first lower rivet hole 193 defined at a position corresponding to the first rivet hole 191 of the cap plate 170. The first lower rivet hole 193 may be defined in one edge area of the lower insulating member 180. According to some embodiments, the first terminal connection part 121 of the first current collector 120 inserted into the first insertion groove 183 of the lower insulating member 180 may also be provided with a first current collector rivet hole 195 defined in a position corresponding to the first rivet hole 191 of the cap plate 170. According to some embodiments, the first lower rivet hole 193 may be defined in both upper and lower portions defining the first insertion groove 183 of the lower insulating member 180.

According to some embodiments, the cap plate 170, the lower insulating member 180, and the first terminal connection part 121 may have the first rivet hole 191, the first lower rivet hole 193, and the first current collector rivet hole 195, which are defined at positions corresponding to each other. Referring to the dotted circle in FIG. 2, the first rivet hole 191, the first lower rivet hole 193, and the first current collector rivet hole 195 may be defined in the positions corresponding to each other to provide a path into which the first rivet terminal 141 of the first electrode terminal 140 is inserted. According to some embodiments, a lower portion of the first rivet terminal 141 inserted into the first rivet hole 191, the first lower rivet hole 193, and the first current collector rivet hole 195 may be exposed to a lower side of the lower insulating member 180 and then be lower-riveted.

According to some embodiments, the second rivet terminal 151 of the second electrode terminal 150 may be configured to be lower-riveted by passing through the cap plate 170, the lower insulating member 180, and the second terminal connection part 131. According to some embodiments, the cap plate 170 may be provided with a second rivet hole 192 in the other edge area corresponding to the installation position of the second rivet terminal 151.

According to some embodiments, the lower insulating member 180 may include a second lower rivet hole 194 defined at a position corresponding to the second rivet hole 192 of the cap plate 170. The second lower rivet hole 194 may be defined in the other edge area of the lower insulating member 180. According to some embodiments, the second terminal connection part 131 of the second current collector 130 inserted into the second insertion groove 184 of the lower insulating member 180 may also be provided with a second current collector rivet hole 196 defined in a position corresponding to the second rivet hole 192 of the cap plate 170. According to some embodiments, the second lower rivet hole 194 may be defined in both upper and lower portions defining the second insertion groove 184 of the lower insulating member 180.

According to some embodiments, the cap plate 170, the lower insulating member 180, and the second terminal connection part 131 may have the second rivet hole 192, the second lower rivet hole 194, and the second current collection rivet hole 196, which are defined at positions corresponding to each other. As described above, the second rivet hole 192, the second lower rivet hole 194, and the second current collector rivet hole 196 may be defined in the positions corresponding to each other to provide a path into which the second rivet terminal 151 of the second electrode terminal 150 is inserted. According to some embodiments, a lower portion of the second rivet terminal 151 inserted into the second rivet hole 192, the second lower rivet hole 194, and the second current collector rivet hole 196 may be exposed to a lower side of the lower insulating member 180 and then be lower-riveted.

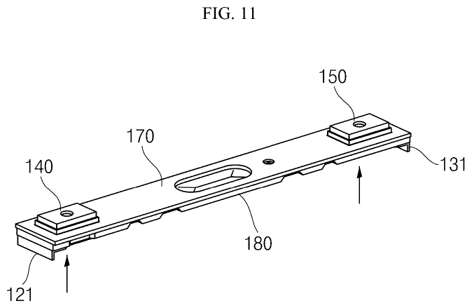

FIGS. 7 to 11 illustrate views sequentially showing a process of manufacturing a secondary battery according to some embodiments. Hereinafter, a method for manufacturing a secondary battery according to some embodiments will be described in more detail with reference to FIGS. 7 to 11.

First, referring to FIG. 7, a vent member 177b may be coupled to a cap plate 170. For example, a vent member 177b may be coupled to the cap plate 170 through assembly and welding. Then, referring to FIG. 8, a lower insulating member 180 may be coupled to the cap plate 170. Then, referring to FIG. 9, a first terminal connection part 121 and a second terminal connection part 131 may be inserted into first and second insertion grooves 183 and 184 of the lower insulating member 180 in a direction of an arrow, respectively. Then, referring to FIG. 10, a semi-assembled first electrode terminal 140 and a second electrode terminal 150 may be assembled with the cap plate 170, the lower insulating member 180, and the first and second terminal connection parts 121 and 131, which are assembled with each other.

According to some embodiments, a first rivet terminal 141 of the first electrode terminal 140 may be inserted into a first rivet hole 191, a first lower rivet hole 193, and a first current collector rivet hole 195, which are aligned with each other, so that a lower end of the first rivet terminal 141 is exposed below the lower insulating member 180. According to some embodiments, a second rivet terminal 151 of the second electrode terminal 150 may be inserted into a second rivet hole 192, a second lower rivet hole 194, and a second current collector rivet hole 196, which are aligned with each other, so that a lower end of the second rivet terminal 151 is exposed below the lower insulating member 180. Then, referring to FIG. 11, lower riveting of lower portions of the first rivet terminal 141 and the second rivet terminal 151 may be performed in the direction of the arrow. The subsequent process may be manufactured through any suitable method of assembling the prismatic-type secondary battery. For example, a process of coupling the electrode assembly 110 to the first and second current collectors 120 and 130, a process of coupling the first electrode connection part 122 and the second electrode connection part 132 to the first terminal connection part 121 and the second terminal connection part 131, and a process of inserting the electrode assembly 110 and the components coupled to the electrode assembly 110 into a case 160 and injecting an electrolyte may be additionally performed.

A battery pack according to one or more embodiments includes at least one battery module and a pack housing having an accommodation space in which the at least one battery module is accommodated.

The battery module may include a plurality of battery cells and a module housing. The battery cells may be accommodated inside the module housing in a stacked form (or stacked arrangement or configuration). Each battery cell may have a positive electrode terminal and a negative electrode terminal and may be a circular type, a prismatic type, or a pouch type according to the shape of battery. In the present specification, a battery cell may also be referred to as a secondary battery, a battery, or a cell.

In the battery pack, one cell stack may constitute one module stacked in place of the battery module. The cell stack may be accommodated in an accommodation space of the pack housing or may be accommodated in an accommodation space partitioned by a frame, a partition wall, etc.

The battery cell may generate a large amount of heat during charging/discharging. The generated heat may be accumulated in the battery cell, thereby accelerating the deterioration of the battery cell. Accordingly, the battery pack may further include a cooling member configured to remove the generated heat and thereby suppress deterioration of the battery cell. The cooling member may be provided at the bottom of the accommodation space at where the battery cell is provided but is not limited thereto and may be provided at the top or side depending on the battery pack.

The battery cell may be configured such that exhaust gas generated inside the battery cell under abnormal operating conditions, also known as thermal runaway or thermal events, is discharged to the outside of the battery cell. The battery pack or the battery module may include an exhaust port for discharging the exhaust gas to prevent or reduce damage to the battery pack or module by the exhaust gas.

The battery pack may include a battery and a battery management system (BMS) for managing the battery. The battery management system may include a detection device, a balancing device, and a control device. The battery module may include a plurality of cells connected to each other in series and/or parallel. The battery modules may be connected to each other in series and/or in parallel.

The detection device may detect a state of a battery (e.g., voltage, current, temperature, etc.) to output state information indicating the state of the battery. The detection device may detect the voltage of each cell constituting the battery or of each battery module. The detection device may detect current flowing through each battery module constituting the battery module or the battery pack. The detection device may also detect the temperature of a cell and/or module on at least one point of the battery and/or an ambient temperature.

The balancing device may perform a balancing operation of a battery module and/or cells constituting the battery module. The control device may receive state information (e.g., voltage, current, temperature, etc.) of the battery module from the detection device. The control device may monitor and calculate the state of the battery module (e.g., voltage, current, temperature, state of charge (SOC), life span (state of health (SOH)), etc.) on the basis of the state information received from the detection device. In addition, on the basis of the monitored state information, the control device may perform a control function (e.g., temperature control, balancing control, charge/discharge control, etc.) and a protection function (e.g., over-discharge, over-charge, over-current protection, short circuit, fire extinguishing function, etc.). In addition, the control device may perform a wired or wireless communication function with an external device of the battery pack (e.g., a higher level controller or vehicle, charger, power conversion system, etc.).

The control device may control charging/discharging operation and protection operation of the battery. To this end, the control device may include a charge/discharge control unit, a balancing control unit, and/or a protection unit.

The battery management system is a system that monitors the battery state and performs diagnosis and control, communication, and protection functions, and may calculate the charge/discharge state, calculate battery life or state of health (SOH), cut off, as necessary, battery power (e.g., relay control), control thermal management (e.g., cooling, heating, etc.), perform a high-voltage interlock function, and/or may detect and/or calculate insulation and short circuit conditions.

A relay may be a mechanical contactor that is turned on and off by the magnetic force of a coil or a semiconductor switch, such as a metal oxide semiconductor field effect transistor (MOSFET).

The relay control has a function of cutting off the power supply from the battery if (or when) a problem occurs in the vehicle and the battery system and may include one or more relays and pre-charge relays at the positive terminal and the negative terminal, respectively.

In the pre-charge control, there is a risk of inrush current occurring in the high-voltage capacitor on the input side of the inverter when the battery load is connected. Thus, to prevent or reduce inrush current when starting a vehicle, the pre-charge relay may be operated before connecting the main relay and the pre-charge resistor may be connected.

The high-voltage interlock is a circuit that uses a small signal to detect whether or not all high-voltage parts of the entire vehicle system are connected and may have a function of forcibly opening a relay if (or when) an opening occurs at even one location on the entire loop.

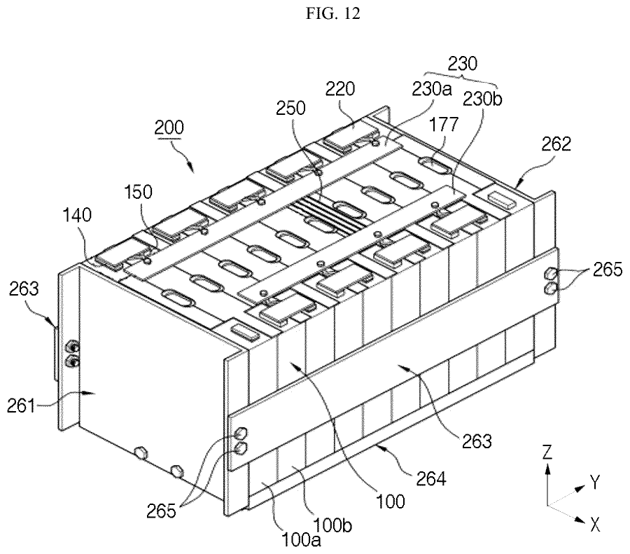

FIG. 12 is a perspective view of an example of a battery module 200.

Referring to FIG. 12, the battery module 200 according to one or more embodiments of the present disclosure includes electrode units 140 and 150, a plurality of battery cells 100 arranged in one direction, a connection tab 220 connecting a battery cell 100a to an adjacent battery cell 100b, and a protection circuit module 230 having one end connected to the connection tab 220. The protection circuit module 230 may include a battery management system (BMS). Further, the connection tab 220 may include a body portion in contact with the electrode units 140 and 150 between the adjacent battery cells 100a and 100b and an extension portion extending from the body portion and connected to the protection circuit module 230. The connection tab 220 may be, for example, a bus bar.

Each battery cell 100 may include a battery case, an electrode assembly received (or accommodated) in the battery case, and an electrolyte. The electrode assembly and the electrolyte react electrochemically to store and release (e.g., generate) energy. Terminal parts 140 and 150 electrically connected to the connection tab 220 and a vent 177 as a discharge passage for gas generated inside the battery case may be provided on one side of (e.g., an upper side of) the battery cell 100. The terminal parts 140 and 150 of the battery cell 100 may be a positive electrode terminal 140 and a negative electrode terminal 150 having different polarities from each other, and the terminal parts 140 and 150 of the adjacent battery cells 100a and 100b may be electrically connected to each other in series or parallel by the connection tab 220, to be described in more detail below. Although a serial connection has been described as an example, the connection structure is not limited thereto, and various connection structures may be employed as desired or necessary. In addition, the number and arrangement of battery cells is not limited to the structure shown in FIG. 12 and may be changed as desired or necessary.

The plurality of battery cells 100 may be arranged in (e.g., may be stacked in) one direction so that the wide surfaces of the battery cells 100 face each other, and the plurality of battery cells 100 may be fixed by the housings 261, 262, 263, and 264. The housings 261, 262, 263, and 264 may include a pair of end plates 261 and 262 facing the wide surfaces of the battery cell 100 and a side plate 263 and a bottom plate 264 connecting the pair of end plates 261 and 262 to each other. The side plate 263 may support side surfaces of the battery cells 100, and the bottom plate 264 may support bottom surfaces of the battery cells 100. In addition, the pair of end plates 261 and 262, the side plate 263 and the bottom plate 264 may be connected by bolts 265 and/or any other suitable fastening members and methods known to those of ordinary skill in the art.

The protection circuit module 230 may have electronic components and protection circuits mounted thereon and may be electrically connected to connection tabs 220, to be described in more detail later. The protection circuit module 230 includes a first protection circuit module 230a and a second protection circuit module 230b extending along the direction in which the plurality of battery cells 100 are arranged in different locations. The first protection circuit module 230a and the second protection circuit module 230b may be spaced from each other at a suitable interval (e.g., a set or predetermined interval) and arranged parallel to each other to be electrically connected to adjacent connection tabs 220, respectively. For example, the first protection circuit module 230a extends on one side of the upper portion of the plurality of battery cells 100 along the direction in which the plurality of battery cells 100 are arranged, and the second protection circuit module 230b extends to the other upper side of the plurality of battery cells 100 along the direction in which the plurality of battery cells 100 are arranged. The second protection circuit module 230b may be spaced from the first protection circuit module 230a at a suitable interval (e.g., a set or predetermined interval) with the vents 177 interposed therebetween but may be arranged parallel to the first protection circuit module 230a. As such, the two protection circuit modules are spaced from each other side-by-side along the direction in which the plurality of battery cells 100 are arranged, thereby relatively reducing or minimizing the area of the printed circuit board (PCB) constituting the protection circuit module. By separately configuring the protection circuit module into two protection circuit modules, unnecessary PCM area can be relatively reduced or minimized. In addition, the first protection circuit module 230a and the second protection circuit module 230b may be connected to each other by a conductive connection member 250. One side of the conductive connection member 250 is connected to the first protection circuit module 230a, and the other side thereof is connected to the second protection circuit module 230b so that the two protection circuit modules 230a and 230b can be electrically connected with each other.

The connection may be performed by any one of soldering, resistance welding, laser welding, projection welding and/or any other suitable connection methods known to those of ordinary skill in the art.

In addition, the connection member 250 may be, for example, an electric wire. In addition, the connection member 250 may be made of a material having elasticity or flexibility. By the connecting member 250, it may be possible to check and manage whether the voltage, temperature, and/or current of the plurality of battery cells 100 are normal. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 250.

In addition, when the battery cell 100 swells, shocks may be absorbed by the elasticity or flexibility of the connection member 250, thereby preventing or reducing damage to the first and second protection circuit modules 230a and 230b.

In addition, the shape and structure of the connection member 250 is not limited to the shape and structure shown in FIG. 12.

As described above, because the protection circuit module 230 is provided as the first and second protection circuit modules 230a and 230b, the area of the PCB constituting the protection circuit module can be relatively reduced or minimized, and the space inside the battery module can be secured, which improves work efficiency by facilitating a fastening work for connecting the connection tab 220 and the protection circuit module 230 and repair work if (or when) an abnormality is detected in the battery module.

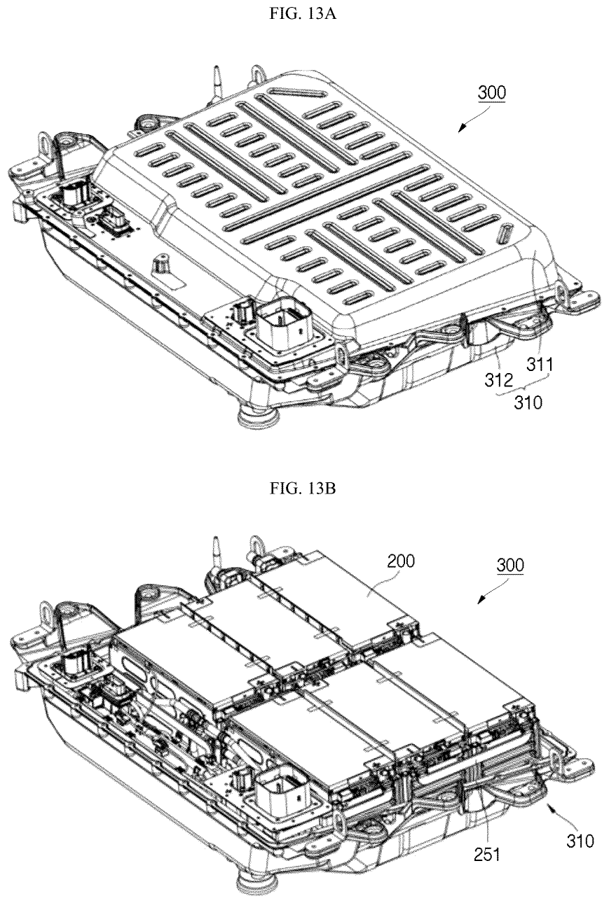

FIGS. 13A and 13B illustrate perspective views of an example of a battery pack 300.

The battery pack may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output.

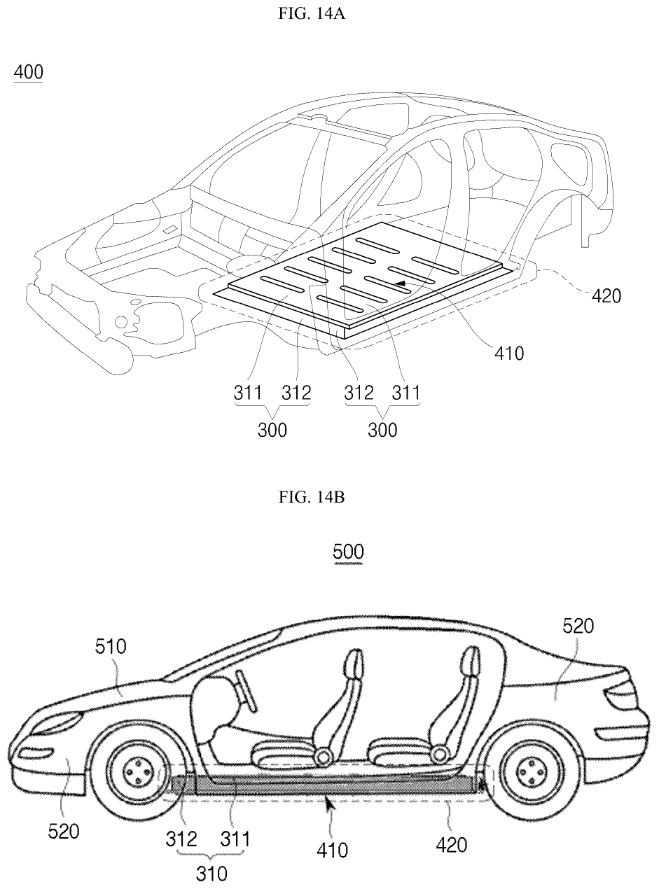

FIGS. 14A and 14B illustrate perspective and side views of examples of a vehicle body and a vehicle components 400.

In FIG. 14A, a battery pack 300 may include a battery pack cover 311, which is a part of a vehicle underbody 410, and a pack frame 312 located under the vehicle underbody 410. The pack frame 312 and the battery pack cover 311 may be integrally formed with a vehicle floor 420. The vehicle underbody 410 separates the inside and outside of a vehicle, and the pack frame 312 may be located outside the vehicle.

Referring to FIG. 14B, a vehicle 500 may be formed by combining additional parts, such as a hood 510 in front of the vehicle and fenders 520 respectively located in the front and rear of the vehicle to a vehicle body 400.

The vehicle 500 may include the battery pack 300 that include the battery pack cover 311 and the pack frame 312, and the battery pack 300 may be coupled to the vehicle body 400.

According to some embodiments, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0sb≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}CO_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn₁₋₆G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth) acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

According to the some embodiments, the upper retainer may be removed to be integrated with the insulating plate, thereby relatively reducing the manufacturing costs and simplifying the process.

According to some embodiments, the current collector may be inserted into the insertion groove of the lower insulating member through the integration of the upper retainer while securing the insulating performance to simplify the assembly process, and the riveting jig hole section for implementing the riveting process on the area on which the lower riveting is not possible due to the integration may be secured.

However, the effects that are capable of being achieved through the present disclosure are not limited to the above-described effects, and other technical effects not mentioned can be clearly understood by those skilled in the art from the description of the invention described below.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A secondary battery comprising:
a case having a space therein;
an electrode assembly in the space of the case;
a cap plate coupled to an upper portion of the case to seal the case;
a current collector comprising a terminal connection part between the electrode assembly and the cap plate and an electrode connection part connected to an end of the terminal connection part in a vertical direction and between the electrode assembly and the case;
an electrode terminal coupled to the terminal connection part of the current collector by passing through the cap plate; and
an insulating member interposed between the cap plate and the electrode assembly,
wherein the insulating member comprises an insertion groove in a side surface thereof, and
at least a portion of the terminal connection part is inserted into the insertion groove of the insulating member.

2. The secondary battery as claimed in claim 1, wherein the insulating member has a plate shape having a thickness and comprises a pair of long sides and a pair of short sides connected to the pair of long sides, and
the insertion groove is in each of the pair of long sides of the insertion groove.

3. The secondary battery as claimed in claim 1, wherein the cap plate comprises:
a vent part defined in a central area of the cap plate;
an electrolyte injection port outside the vent part; and
a rivet hole performing lower riveting of the electrode terminal.

4. The secondary battery as claimed in claim 3, wherein the insulating member comprises:
a lower vent hole in a central area thereof to correspond to a position of the vent part defined in the cap plate; and
an injection hole outside the lower vent hole to correspond to the electrolyte injection port in the cap plate.

5. The secondary battery as claimed in claim 4, wherein the lower vent hole of the insulating member is below the vent part.

6. The secondary battery as claimed in claim 4, wherein the lower vent hole of the insulating member has a size equal to or greater than that of the vent part.

7. The secondary battery as claimed in claim 4, wherein the insulating member is symmetrical left and right with respect to the lower vent hole.

8. The secondary battery as claimed in claim 4, wherein the insulating member has a lower rivet hole in an edge area thereof and performing the lower riveting of the electrode terminal.

9. The secondary battery as claimed in claim 8, wherein the cap plate and the insulating member have the rivet hole and the lower rivet holes defined at positions corresponding to each other, respectively, so as to perform the lower riveting of the electrode terminal, and
each of the rivet hole of the cap plate and the lower rivet hole of the insulating member is at a position corresponding to the position of the electrode terminal.

10. The secondary battery as claimed in claim 8, wherein the terminal connection part has a terminal rivet hole performing the lower riveting of the electrode terminal.

11. The secondary battery as claimed in claim 10, wherein the rivet hole of the cap plate, the lower rivet hole of the insulating member, and the terminal rivet hole of the terminal connection part are at positions corresponding to each other, respectively.

12. The secondary battery as claimed in claim 1, wherein the electrode connection part extends to an end of the terminal connection part and is connected to a side surface of the electrode assembly.

13. The secondary battery as claimed in claim 1, wherein the electrode connection part is coupled to an end of the terminal connection part and is connected to a side surface of the electrode assembly.

14. The secondary battery as claimed in claim 1, wherein the terminal connection part is spaced apart from the electrode assembly by the insulating member.

15. The secondary battery as claimed in claim 1, wherein the cap plate, the insulating member, and the terminal connection part have a rivet hole, a lower rivet hole, and a terminal rivet hole, which are defined to perform lower riveting of the electrode terminal, respectively,
wherein the rivet hole of the cap plate, the lower rivet hole of the insulating member, and the terminal rivet hole of the terminal connection part are defined at positions corresponding to each other, respectively.

16. The secondary battery as claimed in claim 1, wherein a vent part is defined at one side of the cap plate, and
a lower vent hole is defined at one side of the insulating member,
the vent hole of the insulating member is defined below the vent part of the cap plate.

17. A battery pack comprising:
a plurality of battery modules which respectively comprise a plurality of the secondary batteries as claimed claim 1; and
a housing configured to accommodate the plurality of battery modules.
